(19) United States
(12) Patent Application Publication
(10) Pub. No.: US 2014/0043332 A1
(43) Pub. Date: Feb. 13, 2014

(54) METHOD, DEVICE AND SYSTEM FOR GENERATING A TEXTURED REPRESENTATION OF A REAL OBJECT

(71) Applicant: TOTAL IMMERSION, (US)

(72) Inventor: Renan Rollett, Bagnolet (FR)

(73) Assignee: TOTAL IMMERSION, Suresnes (FR)

(21) Appl. No.: 13/685,134

(22) Filed: Nov. 26, 2012

(30) Foreign Application Priority Data
Feb. 13, 2012 (FR) 1251341

(51) Int. Cl. G06T 15/04; G06T 15/50

(52) U.S. Cl. CPC G06T 15/04; G06T 15/506
USPC 345/426; 345/419

(57) ABSTRACT

A particular subject of the invention is a method for generating a textured representation of a real object in a system comprising a data processing device linked to an image acquisition device. After receiving (310) a first image representing said real object in a given pose and after obtaining (320, 325, 330, 335) a second image representing said real object in a pose identical to said given pose, said second image being representative of the transparency of said real object in said given pose, said textured representation is generated (340) by combining said first and second images.

### CROSS-REFERENCE TO RELATED APPLICATIONS

This application claims the benefit of French Application No 1251341, filed Feb. 13, 2012, the entire disclosures of which are incorporated herein by reference.

The present invention relates to the modelling of real objects and more particularly a method, device and system for generating a textured representation of a real object.

Three-dimensional representations of real objects are often used in computer systems for numerous applications such as computer-aided design or simulation. Thus, for example, three-dimensional representations of pairs of spectacles can be used by potential purchasers, in an augmented reality application, to help them to choose a specific pair of spectacles, in particular according to its shape and colour.

The three-dimensional representations are computer entities typically comprising a set of points and/or curves representing surfaces with which textures or a textured representation of an object or a portion thereof can be associated. The textures or textured representations are typically two-dimensional finished surfaces.

Such three-dimensional representations are usually generated from design software applications called CAD applications (acronym for Computer Aided Design).

They can also be created from real objects, for example by digitizing using a scanner which analyses these objects in order to obtain topological information and, if necessary, information relating to appearance such as colours and textures. Typically, a scanner determines the position of a sampling of points, in a predetermined system of coordinates, of the surfaces of the object to be modelled, in order to then extrapolate their shape.

Photographs of the objects can also be used in order to model them by image analysis.

Moreover, according to the applications envisaged, the use of three-dimensional representations can be replaced by the use of a textured representation (two-dimensional representation), that is easier to manage and requires fewer calculation resources. In this case, the textured representation used is chosen according to the angle of view of the object in question.

Thus, there is a need to obtain, rapidly and more economically, textured representations capable of use as they are, or for constructing a three-dimensional representation.

Thus, it subject of the invention is a method for generating a textured representation of a real object in a system comprising a data processing device linked to an image acquisition device, this method comprising the following steps,
receiving a first image representing said real object in a given pose;
obtaining a second image representing said real object in a pose identical to said given pose, said second image being representative of the transparency of said real object in said given pose; and

generating said textured representation by combining said first and second images.

The method according to the invention thus makes it possible to create textured representations of real objects easily and rapidly, while limiting the casts of their creation. Moreover, they can be created by persons having no particular skill, in the modelling of objects or in the field of the real objects in question.

According to a particular embodiment, said combination of said first and second images comprises a point-to-point combination of said first and second images that is particularly simple to implement and does not require any particular processing resources.

Still according to a particular embodiment, the method comprises moreover a step of receiving a third image representing said real object in a pose identical to said given pose, said third image being produced under lighting conditions that are different from the lighting conditions that resulted in said first image, said second image being obtained by processing said third image.

Advantageously, said processing comprises at least one of the steps of filtering, inversion and thresholding of a component or combination of components of each point of said third image for improving the quality of the created textured representations.

According to a particular embodiment, said lighting conditions that resulted in said first image allow frontlighting of said real object and said lighting conditions that resulted in said third image allow backlighting of said real object. The method according to the invention thus makes it possible to limit handling of the real objects the textured representations of which must be obtained, to recover their transparency and to clip, them during a single processing. Moreover, the method according to the invention allows the shadows cast by these real objects to be removed automatically.

TO this end, in particular, the method can moreover comprise a step of controlling selective, activation of the light sources. It can also comprise moreover a step of commanding the acquisition of at least one of said images.

A subject of the invention is also a computer program comprising instructions suitable for the implementation of each step of the method previously described when said programme is executed on a computer as well, as a device comprising means suitable for implementing each step of the method previously described. The advantages gained by this computer program and this device are similar to those previously mentioned.

A subject of the invention is also a system for generating a textured representation of a real object from images of said real object, this system comprising the following devices,

image acquisition device; and

a data processing device connected to said image acquisition device and configured to implement each of the following steps,
a) receiving a first image representing said real object in a given pose;
b) obtaining a second image representing said real object in a pose identical to said given pose, said second image being representative of the transparency of said real object in said given pose; and
c) generating said textured representation by combining said first and second images.

The system according to the invention thus makes it possible to create textured representations of real objects easily and rapidly while limiting the costs of their creation. Moreover, they can be created by persons having no particular skill in the modelling of objects or in the field of the real objects in question.

Advantageously, the system comprises moreover a support suitable for receiving said real object, said support being configured to present said real object in a pose similar to that of said real object in use. The system can thus be preconfigured, the pose of the real objects being associated with that of said support, limiting the processing to be carried out.

According to a particular embodiment, the system comprises moreover a plurality of light sources distributed in at least two groups, at least one light source from a first group capable of activation independently of at least one light source from a second group. Said data processing device can be configured to activate sequentially at least pane light source from said first group and at least one light source from said second group.

Still according to a particular embodiment, the system comprises moreover a cyclorama configured to generate reflections on said real object in said first image to make it possible to control the reflections in the real objects in question.

Other advantages, aims and features of the present invention will become apparent from the detailed description below, given by way of non-limitative example, with reference to the attached figures, in which:

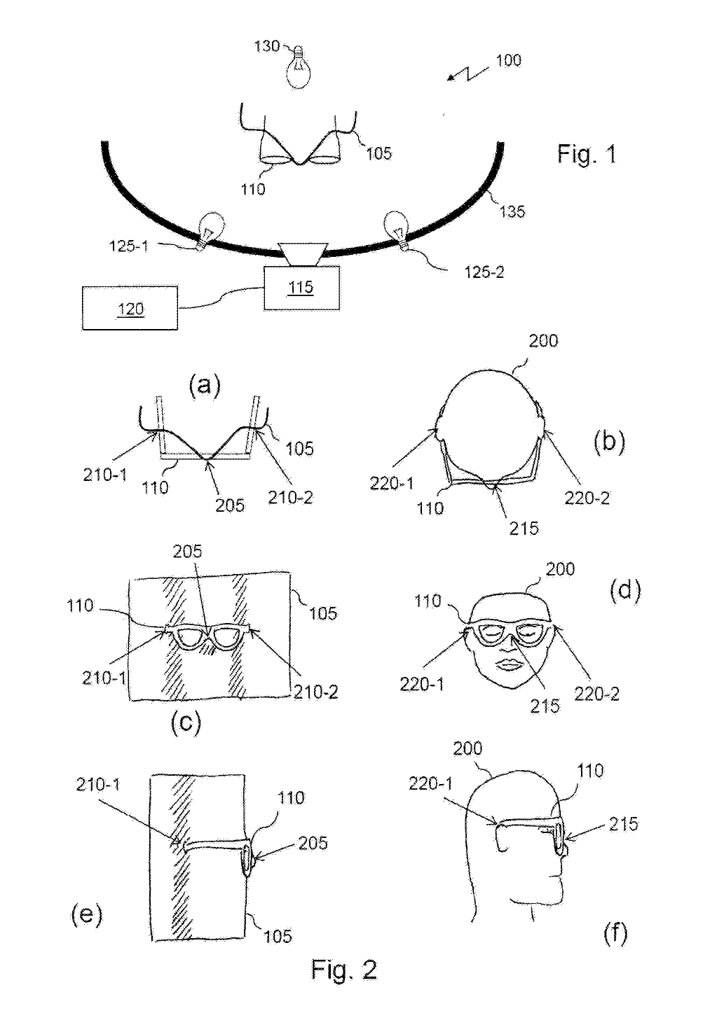

FIG. 1 shows an example of an environment making it possible to implement the invention in order to generate a textured representation of a real object;

FIG. 2, comprising FIGS. 2.a to 2f, illustrates the way in which a real object, a textured representation of which is to be generated, in this case a pair of spectacles, is positioned on a support used to this end and in normal use conditions, i.e. in this case on a face, seen in top, front and side views.

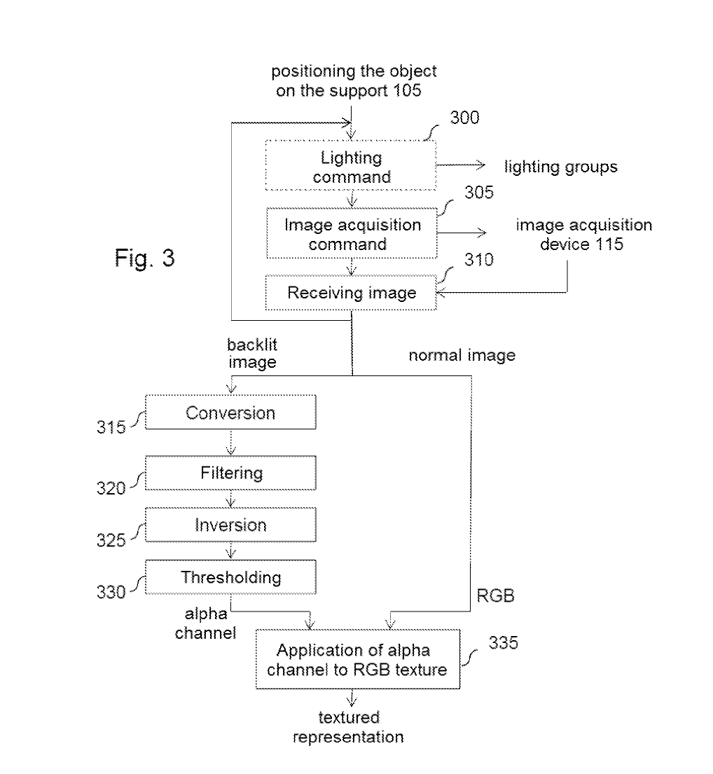

FIG. 3 illustrates diagrammatically certain steps implemented according to the invention for generating a textured representation of a real object; and

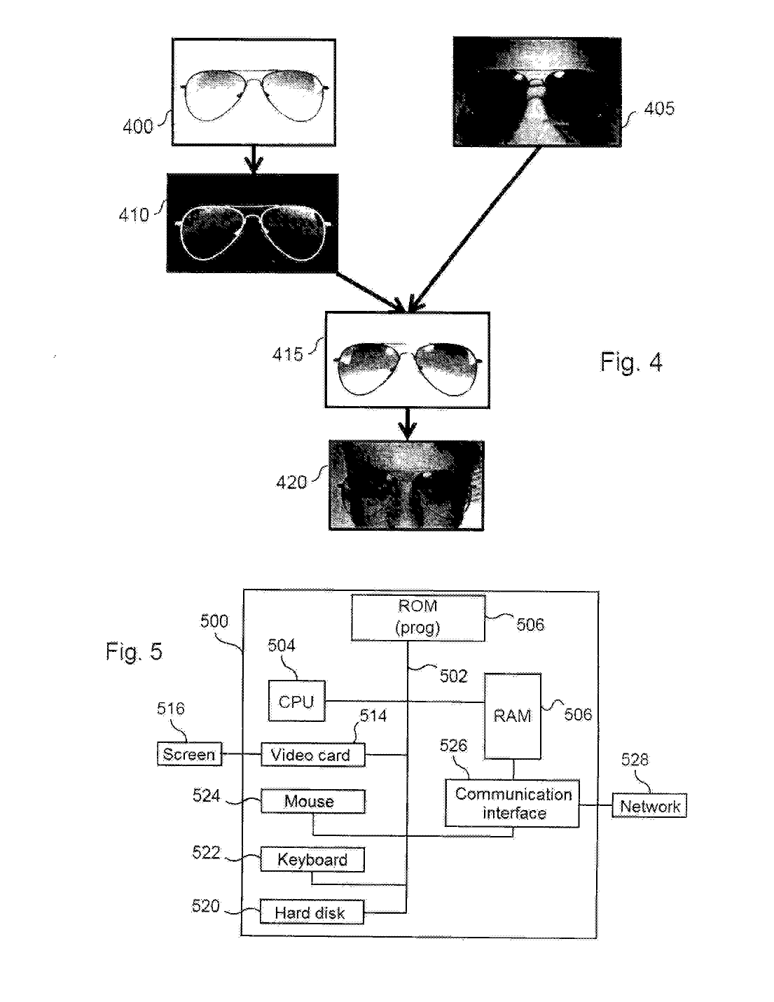

FIG. 4 illustrates an example of implementation of steps described with reference to FIG. 3 for generating a textured representation of a pair of spectacles; and

FIG. 5 illustrates an example of a data processing device suitable for implementing the invention or part of the invention.

Generally, a subject of the invention is the generation of a textured representation of a real object by combining several images of this object. In this case, these images represent the latter in the same pose, with the same angle of view and using the same focal length. According to a particular embodiment, only the lighting conditions are altered between the images used.

According to this particular embodiment, an image obtained under normal lighting conditions can be combined with an image obtained under backlighting conditions, after processing thereof. The backlighting is in this case carried out such that an opaque white surface appears black: only the transparent zones of the object generate intermediate values such as greyscales.

To this end, the invention advantageously uses a physical support for the real objects the textured representations of which are to be generated, one or more image acquisition devices such as cameras and video cameras, and a data processing device of the personal computer or work station type.

The physical support used for holding a real object from which a textured representation is to be generated is suitable for holding the real object under conditions which are close, to the conditions of use of this object. In particular, the physical support makes it possible to maintain the object in the position in which it is used, by masking the areas which are potentially masked during its use.

The support is advantageously produced from a translucent material that reflects light uniformly, in order to facilitate image processing.

It typically consists of a surface that is closed, for example a surface having a spherical or ovoid shape, or open, for example a surface generated by the development of a curve such as a planar curve having the shape of a curly bracket in a particular direction, i.e. extending the curve in this direction, as illustrated in FIGS. 1 and 2.

The support is in this case produced from a translucent material and comprises a light source situated within or behind (with respect to the image acquisition device used).

Alternatively, the support can be produced with a structure that is sufficiently discreet that it does not disturb the generation of textured representations. This can be for example a wire support.

After an object a textured representation of which is to be generated has been placed on the support, several images of this object are obtained from a single viewpoint, using an image acquisition device, while varying the shot conditions, typically the lighting conditions or image acquisition parameters, manually or under the control of a computer. The image acquisition device used is in this case connected to a data processing device of the personal computer type, making it possible to process and analyse the images obtained.

A textured representation generated according to the invention from a real object an then be used for modelling this real object by using, for example, the known so-called impostor technique consisting of applying a texture onto a predetermined three-dimensional model (or template). It can also be used as it is for superimposition onto an image such as described hereinafter.

FIG. 1 shows an example of an environment 100 making it possible to implement the invention in order to generate a textured representation of a real object.

The environment 100 comprises in this case a support 105 configured to receive a real object from which a textured representation of the latter can be generated, in a particular position, in this case a pair of spectacles 110. According to the example given, the environment 100 comprises moreover an image acquisition device 115, for example a photographic device, linked to a computer 120, for example a standard computer of the PC type (acronym for Personal Computer).

The environment 100 also comprises in this case a lighting system constituted by several groups of light sources capable of being activated separately. A first lighting group comprises in this case the light sources 125-1 and 125-2, for example spotlights, and a second group comprises the light source 130, for example a high-power bulb placed behind the support 105 with respect to the image acquisition device 115. In the example given, the first and second groups are activated alternately, the first group allowing frontlighting while the second, group allows backlighting. The activation of these groups can be carried out manually or automatically, for example using a command issued from the computer 120.

The computer 120 generates a textured representation of the pair of spectacles 110 from images acquired by the image acquisition device 115, a first image corresponding to lighting the real object by the light sources 125-1 and 125-2 of the first group and a second image corresponding to lighting the real object by the light source 130 of the second group, as described with reference to FIG. 3.

By way of illustration, the environment 100 comprises moreover in this case a cyclorama 135 placed facing the real object a textured representation of which is generated, i.e. behind or around the image acquisition device 115. The cyclorama 135 comprises a representation of an environment to be reflected on the real object a textured representation of which is generated (when the shot is taken under normal lighting conditions), in order to increase the realism thereof.

The support 105 is for example produced from a plastic material such as PVC (polyvinyl chloride). As illustrated diagrammatically in FIGS. 1 and 2, the support 105 comprises in this case two openings for receiving the ends of the spectacle side pieces and a protrusion suitable for receiving the two bridge supports fixed on the part of the frame situated between the lenses. The two openings and the protrusion are approximately aligned in a horizontal plane.

The image acquisition device 115 is situated in a predetermined position with respect to the support 105 so that the pose of the pair of spectacles 110, when it is positioned on the support 105, is constant and can be predetermined. In other words, the positioning of a pair of spectacles 110 on the support 105 is thus standardized due to the fact that the support has three reference resting points corresponding to the three natural points on which a pair of spectacles rests when worn (the ears and the nose). A single standardized frame of reference, associated with these three reference resting points, is therefore advantageously used for generating a textured representation of pairs of spectacles. This frame of reference is advantageously associated with a reference resting point, for example the resting point of the two bridge supports fired on the part of the frame situated between the lenses, so that it can be easily used during the generation of a textured representation, to make a link between the support used and a pair of spectacles as well as for positioning a model of a pair of spectacles (in the form of a textured representation) on a representation of a face.

The support 105 is in this case such that it is possible, in a side-on camera shot, to mask the rear of the opposite sidepiece and the part of the sidepieces hidden by the ears when the pair of spectacles is worn, and to separate the side pieces in such a way that they are no longer seen in a front view.

It is noted here that if, in FIG. 1, the image acquisition device is placed facing the pair of spectacles, the assembly constituted by the support 105, the pair of spectacles 110 and, optionally, the light source 130 can be turned such that one side of the pair of spectacles 110 is located facing the image acquisition device 115. It is also possible to move the image acquisition device 115 and, optionally, the light sources 125-1 and 125-2 and/or the screen 135. It is thus possible to generate textured representations of a pair of spectacles according to numerous angles of view, thus allowing a suitable textured representation to be selected and superimposed on a photograph of a face, according to the position of the face.

FIG. 2, comprising FIGS. 2a to 2f, illustrates the way in which a real object a textured representation of which is generated, in this case a pair of spectacles, is positioned on a support used for this purpose in normal use conditions, i.e. in this case on a face, shown in top, front and side views;

Seen from above. FIGS. 2a and 2b show the way in which a pair of spectacles 110 is positioned on a support 105 and on a face 200, respectively. As shown, the pair of spectacles 110 lies on three resting points of the support 105, a resting point 205 associated with a protrusion of the support 105, having a role similar to that of a nose for maintaining the pair of spectacles 110 on a resting point 215, and two resting points 210-1 and 210-2, associated with openings formed in the support 105, in which are inserted the ends of the side pieces of the pair of spectacles 110 having a role similar to that of the ears for maintaining the pair of spectacles 110 on resting points referenced 220-1 and 220-2. The use of openings in the support 105 and not simple protrusions makes it possible to mask the end of the side pieces (as the ears do). Of course, protrusions having a specific shape, such as that of ears, can be used as a resting point for the sidepieces and mask their end.

Similarly, FIGS. 2c and 2d show, in front view, the way in which the pair of spectacles 110 is positioned on the support 105 and on the face 200, respectively. Again, as shown, the pair of spectacles 110 rests on the three resting points 205, 210-1 and 210-2 of the support 105, having a role similar to the resting points 215, 220-1 and 220-2 of the face 200, associated with the nose and ears of the wearer of the pair of spectacles 110.

Also similarly, FIGS. 2e and 2f show, in side view, the way in which the pair of spectacles 110 is positioned on the support 105 and on the face 200, respectively. Again, as shown, the pair of spectacles 110 lies on the three resting points 205, 210-1 and 210-2 of the support 105 (the resting point 210-2 being in this case masked by the support 105), having a role similar to the resting points 215, 220-1 and 220-2 of the face 200 (the resting point 220-2 being in this case masked by the face 200), associated with the nose and ears of the wearer of the pair of spectacles 110.

According to the embodiment shown in FIG. 1, two lighting groups are placed one on each side of the support 105, one allowing frontlighting and the other, backlighting. An image of the real object is acquired by the image acquisition device 115 for each of these lighting situations.

As described previously, the image acquisition device used is connected to a computer, for example using a connection of USB type (acronym for Universal Serial Bus).

According to a particular embodiment, this connection is bidirectional. This allows the image acquisition device to be controlled, in particular for taking the shots and, if appropriate, to allow adjustments to be carried out such as control of the exposure time and of the ISO sensitivity of the photograph. It also allows the transfer of the acquired images to a mass memory, for example a hard disk, of the computer to which the image acquisition device is connected.

FIG. 3 illustrates diagrammatically certain steps implemented according to the invention for generating a textured representation of a real object.

The method describes in this case the generation of a textured representation of a real object from two images thereof obtained without altering the position of the object or that of the image acquisition device (or its optic) but by altering the lighting conditions. Combining these images makes it possible to generate automatically a textured representation of the object.

After the real object a textured representation of which is to be generated, in this ease a pair of spectacles, has been positioned on the support 105 provided for this purpose, in a predetermined position, a command can be issued by the computer 120, if it is linked to the lighting groups, to activate light sources (step 300). If the computer 120 is not linked to the lighting groups (or according to the configuration of the system), the activation of the light sources is controlled by a user or by another system.

A command is then issued by the computer 120 to the image acquisition device 115 for the acquisition of an image (step 305). This command can comprise a simple instruction for the acquisition of an image or a more complex command intended for configuring the image acquisition device(s) according to specific parameters. Alternatively, the command is intended to save one or more images streamed to the computer.

This command can be generated manually, by a user, or automatically for example by the detection of the presence of the real object on the support provided for this purpose (such detection em be carried out by image analysis or using contacts) and particular lighting conditions.

The acquired image(s) are received by the computer in a step referenced 310.

As shown, steps 305 and 310 as well as, if appropriate, step 300 are repeated for the different lighting conditions, in this ease for frontlighting and backlighting conditions.

No particular operation is in this case directly carried out on the image corresponding to normal lighting conditions. This image is considered as a texture of the RGB type (acronym for Red, Green and Blue), i.e. a colour image comprising several components (each coordinate point (i, j) is defined by three components R_{i,j}, G_{i,j} and B_{i,j}). This could also be a greyscale image or an image encoded in another format.

The image obtained, under backlighting conditions is in this case converted to a greyscale image (if it is a colour image) in order to facilitate processing thereof (step 315). Such a conversion is typically performed according to the following formula,

NG_{i,j}=αR_{i,j}+βG_{i,j}+γB_{i,j}

where α+β+γ=1, R_{i,j}, G_{i,j} and B_{i,j} are the red, green and blue components of a point having coordinates (i, j) and NG_{i,j} represents the greyscale of this point. Typically, α=0212.5, β=0.7154 and γ=0.0721 and the values of R_{i,j}, G_{i,j}, B_{i,j} and NG_{i,j} vary between Vₘᵢₙ=0 and Vₘₐₓ=255.

A filtering step is in this case then carried out (step 320) in order to isolate the light and dark opaque zones. To this end, two thresholds θ₁ and θ₂ can be used according to the following relationship,

if Vₘᵢₙ≦NG_{i,j}≦θ₁,NG_{i,j}=Vₘᵢₙ and

if θ₂≦NG_{i,j}≦Vₘₐₓ,NG_{i,j}=Vₘₐₓ

By way of illustration, the values of these thresholds can be the values θ₁=10 and θ₂=245

An inversion is then in this case carried out on the image (step 325) according to the following relationship,

NG′_{i,j}=Vₘₐₓ−NG_{i,j}

where NG′_{i,j} represents the inverse of NG_{i,j}.

and thresholding is preferably earned out (step 330), for example according to the following relationship,

$${CA}_{i , j} = {V}_{min} + {V}_{max} ( \frac{{NG}_{i , j}^{′} - {V}_{min}}{{V}_{max} - {V}_{min}} )$$

where CA_{i,j} represents the transparency value of the coordinate point (i, j) also called alpha channel value.

Such thresholding can of course be defined by a user, with the assistance for example of a function or several predetermined functions and/or parameters. Such functions can in particular be created by the use of Bezier curves.

In a following step (step 335), the component of the alpha channel (CA_{i,j}) is combined with the RGB components (R_{i,j}, G_{i,j} and B_{i,j}) of each point of the image obtained under normal lighting conditions in order to generate a textured representation of the real object placed on the support. Each point of the textured representation is thus characterized by a transparency component and colour components (or a greyscale component).

FIG. 4 illustrates an example of implementation of steps described with reference to FIG. 3 for generating a textured representation of a pair of spectacles.

More precisely, FIG. 4 shows art image 400 representing a backlit pair of spectacles, for example using a high-power bulb placed behind the translucent support on which the pair of spectacles is placed, and an image 405 representing this same pair of spectacles, placed on the same support with the same pose, under normal lighting conditions. Images 400 and 405 have been obtained with the same image acquisition device, the position of which with respect to the support of the pair of spectacles is unchanged.

Image 410 represents image 400 after processing, i.e. the transparency values obtained. Image 410 is then combined with image 405 to create the textured representation shown in image 415. As described previously, this textured representation comprises RGB-type texture data and transparency data (alpha channel).

This textured representation can be superimposed on an image in order to simulate, for example, spectacle-wearing as shown in image 420. The latter results from the superimposition of the textured representation shown in image 415 onto an image representing a face.

It is observed in this case that the calibration of a textured representation obtained according to the invention can be carried out on the basis of shot data, in particular the position of the real object a textured representation of which is to be generated on the support used, the position of the support used with respect to the image acquisition device used and the parameters of the image acquisition device such as the focal length.

As described previously, the textured representation can be used for modelling the real object in question by using, for example, a predetermined template and a technique such as the impostor technique consisting of applying a texture onto a predetermined three-dimensional model.

The method described previously can thus be used to obtain textured representations of sunglasses by obtaining, levels of transparency of the lenses, variations and shading as well as, if appropriate, engravings on the lenses. It can also be applied, with respect to clothing, noting that it can be used for all types of clothing, without restriction of colour (this clipping method is thus more reliable than a method of the chromakey type in which the reference colour cannot be used for the real objects). It can also be applied with respect to jewelry, as this clipping method avoids projecting a background colour onto the reflective materials (the use of an algorithm of the chromakey type applied to an item of jewelry such as a ring creates numerous green reflections in the material).

The textured representation obtained can in particular be used for illustration, for example a photograph on a harmonious background of any colour, for static fitting onto a photograph (thus a single clipped shot of a pair of spectacles can be used to fit the pair of spectacles onto an identity photograph), for dynamic fitting onto a series of photographs (for this purpose. a series of views of the objects is taken (360 views) so as to display the view corresponding to the orientation of the user at each moment) or for generating a model as described previously.

Moreover, the use of a cyclorama makes it possible to control the reflections in the real object a textured representation of which is generated, thus making it possible to see a particular environment reflected on real objects that are very reflective such as jewelry or pairs of spectacles.

FIG. 5 illustrates an example of a data processing device, which can be used to implement the invention at least partially, in particular the steps described with reference to FIG. 3. The device 500 is for example a computer of the PC type.

The device 500 preferably comprises a communication bus 502 to which are connected:

a Central Processing Unit (CPU) or microprocessor 504;

a Read Only Memory (ROM) 506 which can contain the operating system and programs such as “Prog”; and

a Random Access Memory (RAM) or cache memory 408 containing registers capable of saving the variables and parameters created and modified during the execution of the above-mentioned programs.

Optionally, the device 500 can also have the following elements:

a communication interface 526 connected to a communication network 528, for example the Internet, the interface being capable of sending and receiving data;
a graphics card 514 connected to a screen 516;
a hard disk 520 which can comprise the above-mentioned programs “Prog” and the data processed or to be processed according to the invention;
a keyboard 522 and a mouse 524 or any other pointing device such as a light pen, a touch screen or a remote control making it possible for the user to interact with the programs according to the invention; and
a memory card reader (not shown) capable of reading from it or writing to it the data processed or to be processed according to the invention.

The communication bus allows communication and interoperability between the different elements included in the device 500 or linked thereto. The representation of the bus is not limitative and, in particular, the central processing unit is capable of communicating instructions to any element of the device 500 directly or via another element of the device 500.

The executable code of each program allowing the programmable device to implement the procedures according to the invention can be stored, for example, on the hard disk 520 or in read only memory 506

According to a variant, the executable code of the programs can be received using the communication network 528, via the interface 526, for storage in a way identical to that described previously.

More generally, the program(s) can be loaded into one of the storage means of the device 500 before being executed.

The central processing unit 504 will control and direct the execution of the instructions or portions of software code of the program or programs according to the invention, instructions which are stored on the hard disk 520 or in the read only memory 506 or in the other above-mentioned storage elements. When powered up, the program or programs which are stored in a non-volatile memory, for example the hard disk 520 or the read only memory 506, are transferred to the random access memory 508 which then contains the executable code of the program(s) according to the invention, as well as the registers for storing the variables and parameters necessary far the implementation of the invention.

It should be noted that the communication device containing the device according to the invention can also be a programmed device. This appliance then contains the code of the computer programme(s), for example fixed in an application-specific integrated circuit (ASIC).

Of course, to satisfy specific requirements, a person skilled in the field of the invention can apply modifications to the preceding description. In particular, although the invention has been particularly described in the context of modelling pairs of spectacles, it can be implemented for other real objects.

1. A method for generating a textured representation of a real object in a system comprising a data processing device linked to an image acquisition device, the method comprising:
receiving a first image representing said real object in a given pose;
obtaining a second image representing said real object in a pose identical to said given pose, said second image being representative of the transparency of said real object in said given pose; and
generating said textured representation by combining said first and second images.

2. The method of claim 1, wherein said first and second images comprises a point-to-point combination of said first and second images.

3. The method of claim 1, further comprising: receiving a third image representing said real object in a pose identical to said given pose, wherein said third image being produced under lighting conditions that are different from the lighting conditions that resulted in said first image; and processing said third image to obtain said second image.

4. The method of claim 3, wherein processing said third image further comprises at least one of the steps of filtering, inversion and thresholding of a component or of a combination of components of each point of said third image.

5. The method of claim 3, wherein said lighting conditions that resulted in said first image allow frontlighting of said real object and said lighting conditions that resulted in said third image allowing backlighting of said real object.

6. The method of claim 3, further comprising controlling selective activation of light sources.

7. The method of claim 1, further comprising commanding the acquisition of at least one of said images.

8. A computer program stored on a non-transitory storage medium comprising instructions to cause a processor of a computer to carry out the method according to claim 1.

9. A device for generating a textured representation of a real object in a system comprising a data processing, device linked to an image acquisition device, the device comprising a processor configured to:
receiving a first image representing said real object in a given pose;
obtaining a second image representing said real object in a pose identical to said given pose, said second image being representative of the transparency of said real object in said given pose; and
generating said textured representation, by combining said first and second images.

10. A system for generating a textured representation of a real object from images of said real object, the system comprising:
an image acquisition device; and
a data processing device connected to said image acquisition device and configured to:
receive a first image representing said real object in a given pose;
obtain a second image representing said real object in a pose identical to said given pose, said second image being representative of the transparency of said real object in said given pose; and
generate said textured representation by combining said first and second images.

11. The system of claim 10, further comprising a support suitable for receiving said real object, said support being configured to present said real object in a pose similar to that of said real object in use.

12. The system of to claim 10, further comprising a plurality of light sources distributed in at least two groups, wherein at least one tight source from a first group is activated independently of at least one light source of a second group.

13. The system of claim 12, wherein said data processing device is configured to activate sequentially at least one light source of said first group and at least one light source of said second group.

14. The system of claim 10, further comprising a cyclorama configured to generate reflections on said real object in said first image.
